(19) United States
(12) Patent Application Publication
(10) Pub. No.: US 2003/0110273 A1
(43) Pub. Date: Jun. 12, 2003

(54) High speed, high security remote access system

(76) Inventor: Paul A. Ventura, Ontario (CA)

Correspondence Address: Joseph R Keating, Keating & Bennett, Suite 312, 10400 Eaton Place, Fairfax, VA, 22030, US

(21) Appl. No.: 10/220,601

(22) PCT Filed: Mar. 2, 2001
(86) PCT No.: PCT/CA01/00262

(30) Foreign Application Priority Data
Mar. 3, 2000 (CA) 2,300,066

(51) Int. Cl. G06F 15/16

(52) U.S. Cl. 709/229

(57) ABSTRACT

A method and apparatus which is capable of providing high-speed, high security remote access,

### FIELD OF THE INVENTION

The present invention relates in general to remote access systems and more specifically to a method and apparatus for providing a high speed, high security remote access system.

### BACKGROUND OF THE INVENTION

With the continued growth of computer use in businesses. many companies are beginning to store their documents in a central network server. In most cases, documents are shared between employees and therefore having all the documents stored in a central location improves the availability of these documents. Many of these documents are private in nature and therefore access should be restricted to employees and not available to the public. This is generally achieved via a firewall or by restricting remote access to the server.

However, with the evolution of business, many employees work out of the office. There may be occasions when the employee is out of town on business or even working from home and has forgotten a document. Instead of contacting the office and having someone fax the document. which is not possible after working hours, the employee may retrieve the document by remotely accessing the server. However, by allowing remote access to the server, the server runs the risk of being illegally accessed by outside parties. If the outside parties are able to illegally access the server, private documents may be stolen.

Also, when the employee remotely accesses the server, the document retrieval process is generally quite slow. By using a direct dial-up connection, the document retrieval process is restricted to the speed of the modem being used.

A firewall separates a network into two segments. A private segment (the inside) which is usually the LAN and a public segment (the outside) which is usually the Internet. In its most secure configuration a firewall will allow users from the inside through to the outside but will not allow users from the outside in. However, ports can be left open for the purpose of “Business to Business” or giving remote access to employees when they are out of the office. A port acts like a door on the public side of the firewall that can be opened or closed by the firewall software. There are usually 65,000 ports on a firewall of which all can be opened or closed. Ports are left open so that users on the public segment can request access from the firewa ,into the private segment. Unfortunately, the ports can be hacked if they are open or left opened.

### SUMMARY OF THE INVENTION

In accordance with the present invention, there is provided a method and apparatus which is capable of providing high-speed, high security remote access. The present invention allows an employee to securely access a network server via the Internet. By accessing the server via the Internet, the employee is able to quickly retrieve the necessary documents and exit the server system.

According to another aspect of the invention, security is provided in the form of a switch and a software module, which opens specified ports after being instructed by a remote computer.

### GENERAL DESCRIPTION OF THE DETAILED DRAWING

An embodiment of the present invention is described below with reference to the accompanying drawing, in which:

FIG. 1 is a schematic diagram of a high speed, high security remote access system of the present invention; and

FIG. 2 is a schematic diagram of a network to network remote access system of the present invention.

### DETAILED DESCRIPTION OF THE PREFERRED EMBODIMENT

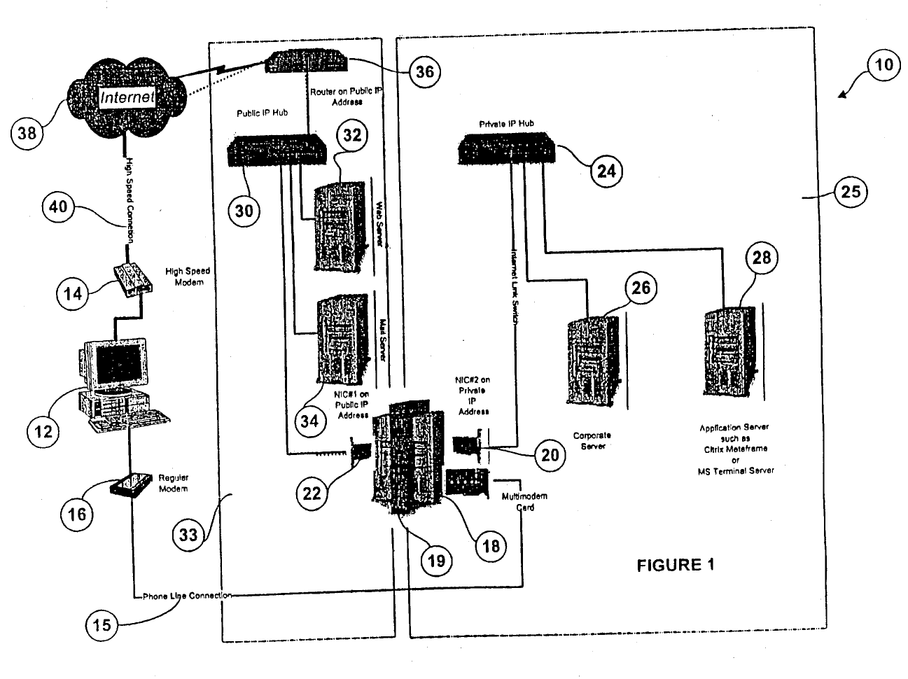

Turning to FIG. 1, a high speed, high security remote access system is shown. The remote access system 10 comprises a remote client computer 12 connected to a high speed modem 14 and a regular modem 16. The regular modem 16 is connected, via a phone line connection 15, to a communication server 18 located at a site (e.g. at a company ). The communication server 18 includes a firewall server 19. The communication server 18 comprises at least two network interface cards (NIC) 20 and 22. NIC 22 contains a Public IP address while NIC 20 contains a private IP address. NIC 20 is connected to a Private IP hub 24 which, in turn, is connected to a corporate server 26 and an application server 28. NIC 22 is connected to a public IP hub 30 which. in turn is connected to a web server 32. a mail server 34 and a router 36. The private hub 24 the corporate server 26 and the application server 28 form a private network 25 while the public hub 30, the web server 32 and the mail server 34 form a public network 33. The private network 25 stores the private documents and should not be accessible by outside parties and therefore requires extra security features. The public network 33 does not require the same security or privacy. Since the web server 32 or the e-mail server 34 are not included in the private network 25, outside parties are able to access the two servers 32 and 34 and e-mail may be sent and received. Distribution of the corporate server 26 and application server 28 in a private network 25 and the web server 32 and the mail server 34 in a public network will be well known to one skilled in the art.

The router 36 contains the public IP address for the location of the firewall server 19 on the Internet. The client computer 12 accesses the Internet 38 via the high-speed modem 14 using a high-speed connection 40. The client computer 12

In operation, the firewall server 19 acts as a control center. In a default mode, the firewall server 19 is a Network Address Translation (NAT) server and does not allow any of the ports to be open. It will be understood by one skilled in the art that high-speed access to the private hub 24 is via ports located in the firewall server 19. When an authorized remote user has successfully logged into the system, the firewall server 19 randomly opens a port in the firewall and via the phone line connection 15. notifies the client computer 12 which port has just been opened. The client computer 12 then connects to the to the private hub 24 via this opened port using the high speed modem 14. This port remains open for a fraction of a second. Subsequently, a new port is randomly opened and the client computer 12 is informed via the phone line connection 15. This technique is known as port scrambling.

In order to access the corporate server 26 or application server 28 via the high speed connection 40; and to ensure the privacy and integrity of the information traveling via the high-speed connection 40, encryption is used. The key to encrypt and decrypt the information traveling via the high-speed connection 40 is randomly generated by the firewall server 19. This key is sent by the firewall server 19 to the client computer 12 via the phone line connection 15. The client computer 12 uses the key to decrypt any incoming information from the firewall server 19 and encrypt any outgoing information to the firewall server 19. A new key is randomly generated by the firewall server 19, many times per second. In order to provide a matching pair of keys, the high-speed connection 40 and the phone line connection 15 must originate from the same client computer 12.

In the present invention, high security on a high speed Internet connection to the private network 25 is achieved by sending a new encryption key to the client computer 12 every fraction of a second. Security is drastically enhanced by constantly changing the encryption key and port scrambling. It will be understood that if the same port is chosen by two separate client computers, both computers may access the corporate server 26 or application server 28 via the same port.

It will also be understood that the present invention may be implemented on a various number of servers such as a Linux server, an NT server or a Novell server.

It will be appreciated that. although an embodiment of the invention has been described and illustrated in detail, various changes and modification may be made. For example, the present invention may include caller ID. In this manner, only select phone numbers are authorized to access the corporate server 26 or application server 28. This enhances the security of the remote access system 10 by not allowing unauthorized phone numbers to access the communication server 18 in an attempt to gain illegal entry. Yet another modification may be to include User ID and password log in resulting in a further level of security being provided to the company network. Yet another modification may be to randomly generate a password such that an access port only allows access from the client computer's IP address using said password. Another security enhancement may be to include dial back security. In this manner, the communication server 18 disconnects the initial call, looks up the user's phone number and dials the client computer 12.

According to another embodiment of the present invention, there is provided the application of this invention to “Business to Business” settings of interconnecting at least two private networks over a public network such as the Internet. More than two private networks may be interconnected simultaneously over the Internet accordingly to the present invention. Examples of such applications include where a branch office network wants to connect up to head office network over the Internet; a customer wants to connect to supplier's database, where the supplier is overseas, therefore the most cost effective way to do it is via the Internet: and where a corporate network needs to connect up to an ASP (application service provider) that is hosting the company's accounting package.

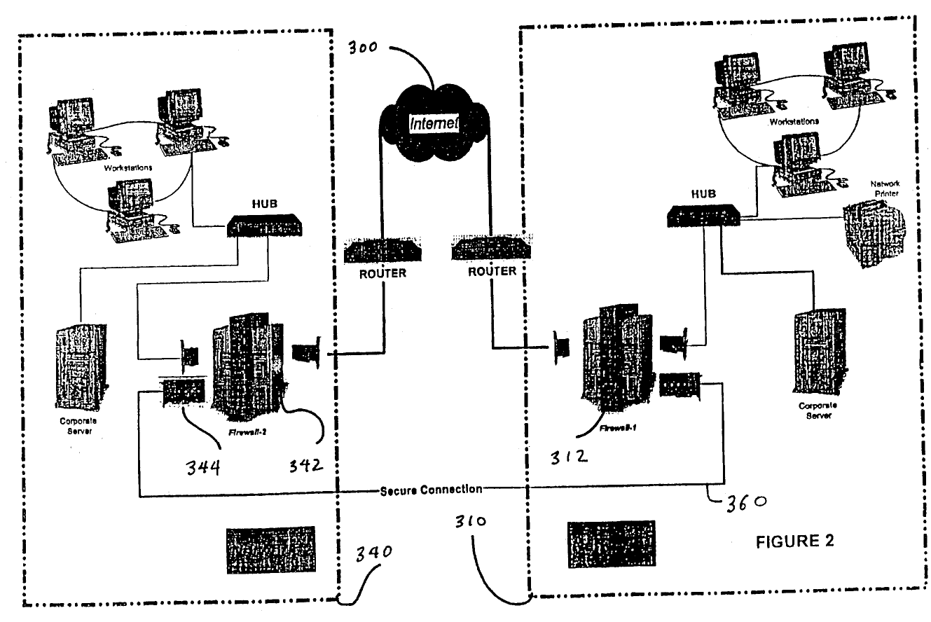

FIG. 2 shows a two private network interconnection over the Internet 300, each private network (network-1 310 and network-2 340) connect to the Internet 300 through a communications server with a firewall server (firewall-1 312 and firewall-2 342). When a user from network-1 310 wants to access network-2 340, firewall-1 312 calls firewall-2 342 via a secure connection 360 such as a telephone line. Firewall-2 342 is equipped with a device 344 that detects the caller ID which checks that the call is from firewall-1 312 to ensure that the caller ID received, matches with the one in the database for the firewall that is logging in. To enhance security, firewall-2 342 may further use dial-back security. In other words, after the firewall-1 312 logs in, the firewall-2 342 server hangs-up and calls firewall-1 312 server back at its telephone number to complete the authentication. This process of using caller ID and dial-back physically verifies that the callers are who they say they are.

Once firewall-1 312 has been authenticated via the secure connection 360, firewall-2 342 sends firewall-1 312 a port number and a randomly generated password. Firewall-2 342 also requests and receives the IP address of Firewall-1 312. Firewall-2 342 then opens the specified port and only allows access from Firewall-1 312 IP address and password to pass through it. Depending on the level of security desired, the secure connection 360 is severed at the end of the log in process, but it can be maintained throughout the entire session for enhanced security. Firewall-1 312 also provides firewall-2 342 with a port number and a randomly generated password for access or return packets from the private network of the firewall-2 342 side. Port scrambling by both firewall-1 312 and firewall-2 342 also enhances security.

The above disclosure generally describes the present invention. A more complete understanding can be obtained by reference to the following specific Examples. These Examples are described solely for purposes of illustration and are not intended to limit the scope of the invention. Changes in form and substitution of equivalents are contemplated as circumstances may suggest or render expedient. Although specific terms have been employed herein, such terms are intended in a descriptive sense and not for purposes of imitation.

### EXAMPLES

The examples are described for the purposes of illustration and are not intended to limit the scope of the invention.

For a client computer accessing a private network over a public network, in a low security mode: the client computer is physically authenticated via a secure connection and caller ID or dial-back security, a firewall server sends the client computer a port number and password, the client computer sends the firewall server its IP address, handshaking between the client computer and firewall server is maintained via the secure channel until a high speed connection through the unsecured public network is in place the secure connection is severed, and the port closes once this session is over.

In a medium security mode: the client computer is physically authenticated via the secure connection and caller ID or dial-back security; the firewall server sends the client computer a port number and password: client computer sends firewall server its IP address; handshaking between the client computer and firewall server is maintained via the secure channel until a high speed connection through the unsecured public network is in place; the secure connection is severed but the client computer is re-authenticated periodically via the secure connection (for example every 15 minutes); with every re-authentication the port number and password are changed; and the port is closed once this session is over.

In a high security mode: the client computer is physically authenticated via the secure connection and caller ID or dial-back; firewall server sends client computer a port number and password; client computer sends firewall server it's IP address; handshaking between the client computer and firewall server is maintained via the secure channel until a high speed connection through the unsecured channel is in place; the secure connection stays active throughout the session and if the secure connection is severed at any time during the session the port is closed, the port number and password are constantly changed and the updates are sent to the client computer via the secure connection; and the port remains open as long as there exists a secure connection.

For two or more private networks interconnecting over a public network, above security levels can also be similarly set for each firewall server of each private network.

Although preferred embodiments of the invention have -been described herein, it will be understood by those skilled in the art that variations may be made thereto without departing from the spirit of the invention or the scope of the appended claims.

What is claimed is:

1. A method of providing over a public network access by a client computer to a network having a public network address protected by a firewall of a communications server, comprising
receiving a request for access to the network from the client computer over a secured channel connected to the communications server;
opening an access port having a port number for accessing the network pass the firewall; and
sending the port number to the client computer.

2. The method of claim 1, wherein the request further comprises a client public network address of the client computer on the public network and the access port is set to communicate only with the client public network address.

3. The method of claim 2, further comprises changing the number of the access port at selected intervals and communicating the changed number to the client computer over the secured channel for continued access to the network.

4. The method of any of claims 1 to 3, further comprises encrypting communications between the client port and the access port and providing a new encryption key to the client computer at selected intervals over the secured channel.

5. The method of any of claims 1 to 4, further comprises providing a password to the client computer over the secured channel for password protected access to the access port.

6. The method of any of claims 1 to 5, wherein the secured channel comprises a telephone line.

7. The method of claim 6, further comprises verifying identity of the client computer by at least one of dialing back, allowing access from predetermined telephone numbers only as confirmed by caller ID, and requiring dial back at selected intervals.

8. The method of any of claims 1 to 7, wherein the public network comprises the Internet.

9. The method of any of claims 1 to, 8, wherein the client computer is an another communications server to another network.

10. A remote access system for providing a client computer access to a network having a public network address, over a public network, comprising
a communications server for protecting the network from unauthorized access; and for communicating with the client computer over a secured channel and over the public network and where upon receiving a request for access to the network over a secured channel from the client computer, opening an access port having a port number for accessing the network pass a firewall, and sending the port number to the client computer.

11. The system of claim 10, wherein the request further comprises a client public network address of the client computer on the public network and the access port is set to communicate only with the client public network address.

12. The system of claim 11, further comprising changing the port number of the access port at selected intervals and communicating the changed port number to the client computer over the secured channel for continued access to the network.

13. The system of any of claims 10 to 12, further comprising a encryption system for encrypting communications between the client computer and the communications server and providing a new encryption key to the client computer at selected intervals over the secured channel.

14. The system of any of claims 10 to 13, further comprising providing a password to the client computer over the secured channel for communications between the client computer and the access port.

15. The system of any of claims 10 to 14, wherein the secured channel comprises a telephone line.

16. The system of claim 15, wherein the secured channel further comprising verification features of at least one of dialing back, allowing access from predetermined telephone numbers only as confirmed by caller ID, and requiring dial back at selected intervals.

17. The system of any of clams 10 to 16, wherein the public network comprises the Internet.

18. The system of any of claims 10 to 17, wherein the client computer is an another communications server to another network.
